(19) United States
(12) Patent Application Publication
(10) Pub. No.: US 2025/0145179 A1
(43) Pub. Date: May 8, 2025

(54) TRAJECTORY GENERATION FOR MOBILE AGENTS

(71) Applicant: Five AI Limited, Cambridge (GB)

(72) Inventor: Anthony Knittel, Cambridge (GB)

(73) Assignee: Five AI Limited, Cambridge (GB)

(21) Appl. No.: 18/835,554

(22) PCT Filed: Feb. 2, 2023
(86) PCT No.: PCT/EP2023/052611

§ 371 Date: Aug. 2, 2024

(30) Foreign Application Priority Data
Feb. 3, 2022 (GB) 2201398.1

(51) Int. Cl. B60W 60/00; B60W 30/09

(52) U.S. Cl. CPC B60W 60/0011; B60W 30/09; B60W 60/0015

(57) ABSTRACT

A method of generating at least one trajectory in scenario comprising an agent navigating a mapped area, the method comprising: receiving an observed state of the agent and map data of the mapped area; generating a set of multiple trajectory basis elements from the observed state of the agent based on the map data; processing one or more scenario inputs in a neural network to generate a set of weights, each weight corresponding to one of the trajectory basis elements; and generating a trajectory for the agent by weighting each trajectory basis element by its corresponding weights and combining the weighted trajectory basis elements.

### TECHNICAL FIELD

The present disclosure pertains to trajectory generation for mobile agents. The present techniques have various application in autonomous driving and robotics more generally.

### BACKGROUND

In the field of autonomous driving and robotics more generally, generating realistic trajectories is an important task. In prediction, the task of predicting the behaviour of agents, such as vehicles, pedestrians and other road users, is important in order for the autonomous vehicle to plan a safe route. In planning, planned trajectories need to be generated in a given scenario that it is possible for a robot (the ego robot) to follow.

Some existing methods of trajectory estimation use deep neural networks to generate predicted trajectories for a set of agents based on a set of state histories for those agents. An example of such a method is disclosed in Deo, Nachiket, and Mohan M. Trivedi. “Convolutional social pooling for vehicle trajectory prediction.” Proceedings of the IEEE Conference on Computer Vision and Pattern Recognition Workshops. 2018. In this method, the output of the trajectory generation network is a distribution over a set of co-ordinates defining the position of the agent over a plurality of future timesteps. However, a possible problem with this method is that neural networks are unpredictable and can occasionally produce unexpected outputs. In the context of prediction and planning for autonomous vehicles, this could lead to dangerous outcomes and a minimum safety level cannot be guaranteed.

Neural networks have also been deployed in robotic planners that plan trajectories for an ego vehicle/agent. The use of a neural network to generate a trajectory for an autonomous ego vehicle could lead to unpredictable and dangerous trajectories being planned. WO2021/152047 teaches a multi-stage planning architecture, in which a neural network trajectory generator seeds a constrained optimization stage. The latter is guaranteed to produce a safe trajectory (within defined constraints), but the quality of the final trajectory is dependent on the quality of the seed trajectory generated by the neural network.

Work in the field of autonomous vehicles has therefore often relied on methods that use rules and heuristics for prediction and planning. Other work in the field seeks to mitigate issues with neural network trajectory generators by collecting and training on vast training sets of driving data. This is not always successful, and in any event requires very significant resources to collect and train on the required volumes of data.

Another method disclosed in Vitelli, Matt, et al. “SafetyNet: Safe planning for real-world self-driving vehicles using machine-learned policies.” arXiv preprint arXiv: 2109.13602 (2021), employs a neural-network-based planner trained on expert driving examples to generate trajectories, and checks the trajectories according to a set of requirements including dynamic feasibility, legality and collision probability. If the trajectory generated by the network fails on any of these requirements, the system reverts to a fallback trajectory generated using an existing rule-based trajectory method.

### SUMMARY

Neural networks are one of the most widely used ‘black box’ machine learning models. In principle, a neural network can be constructed to generate a trajectory for an agent in a scenario given a suitable set of input(s) pertaining to the scenario. The nature of those input(s) is highly dependent on the application, but would typically convey one or more physical variables (e.g. one or more of state of the agent, any other agent(s), road/area layout, environmental variable(s) such as temperature, lighting, weather conditions etc.). For a given choice of scenario input, in principle, given sufficient training examples of scenario inputs(s) and corresponding trajectories, the neural network can be trained to generate a plausible trajectory for any given set of scenario inputs. However, their black box nature means they can produce unpredictable results from time to time. Moreover, by their very nature, neural networks are sometimes perceived as unsuitable in applications requiring reliable and explainable results, particularly in applications with safety requirements. This is particularly true in autonomous driving applications, such as prediction and planning of autonomous vehicle behaviour, as unpredictable outputs from a neural network can pose a safety risk. Predicting trajectories for agents directly using a neural network may cause an autonomous vehicle to adjust its own behaviour in response to unreasonable or unrealistic expected behaviour of other agents of the scene. Furthermore, if a neural network is applied directly to plan a trajectory for an ego agent (i.e. in the planning component of an autonomous vehicle stack) and the network produces an unreasonable or unrealistic trajectory based on which the vehicle's controllers adjust the behaviour of the car, this could cause the vehicle to collide with other agents or otherwise behave unsafely.

Described below is a method for applying a neural network to generate trajectories for an agent, such as an autonomous or human-operated vehicle, pedestrian or cyclist, in such a way that the trajectories do not exceed a limit of reasonable behaviour set by a predefined set of basis trajectory elements at any given time. The described techniques have applications in both planning and prediction. In planning applications, a neural network is used to generate a trajectory for an ego agent (vehicle or other mobile robot) attempting to navigate a road layout. In prediction applications, a neural network is used to predict trajectories for other agents, which can in turn be used as a basis for ego trajectory planning (using any form trajectory planner, which may or may not be neural network-based)

The neural network described below generates predicted and/or planned trajectories for vehicles and other agents by first determining a set of basis elements of the trajectories, where these may be based on map data obtained by mapping an area in which the agents are operating, such as the layout of lanes of a road and the speed limits defined along the road, which can be used to define a set of reasonable paths and motion profiles for agents from a given initial state along the road. The neural network can then be trained to generate a set of weights which can be applied to the basis elements to define a trajectory for a given agent based on a set of scenario inputs which provide context of the state of the agent and relevant features of the environment, such as other agents.

The weights of the neural network are applied to the predetermined basis elements, therefore constraining the resulting trajectory to be a weighted sum of a set of reasonable paths and motion profiles. The weights are also normalised so as not to generate a very large weighting on any single basis element. This means that extreme outputs are not possible, as the most extreme weighting simply applies a weight of one to one of the basis elements and a weight of zero to all others.

The method described below solves the problem of unpredictable outputs from neural networks in prediction and planning of agent motion, and allows the use of neural networks in these applications where they would otherwise be deemed unsafe. This allows the benefits of neural networks, such as the ability to learn from large amounts of existing data, to be applied in prediction and planning, and reduces the reliance on manually-defined heuristics for determining predicted goals and trajectories for agents, as well as for planning trajectories for autonomous vehicles.

A first aspect herein is directed to a method of generating at least one trajectory in a scenario comprising an agent navigating a mapped area, the method comprising: receiving an observed state of the agent and map data of the mapped area; generating a set of multiple trajectory basis elements from the observed state of the agent based on the map data; processing one or more scenario inputs in a neural network to generate a set of weights, each weight corresponding to one of the trajectory basis elements; and generating a trajectory for the agent by weighting each trajectory basis element by its corresponding weights and combining the weighted trajectory basis elements.

The multiple trajectory basis elements may comprise multiple basis paths, wherein the weighted basis paths are combined to form a path, the trajectory comprising the path. The multiple trajectory basis elements may comprise multiple basis motion profiles wherein the weighted basis motion profiles are combined to form a motion profile, the trajectory comprising the motion profile. The multiple trajectory basis elements may comprise the multiple basis motion profiles and the multiple basis paths, the trajectory comprising the path and the motion profile.

The basis motion profiles may be generated based on the observed state of the agent and one or more motion profile parameters. The basis motion profiles may be generated by fitting a spline between an observed kinematic state of the agent and a target kinematic state of the agent.

The map may comprise a road layout.

The method may comprise generating a graph representation of the road layout comprising one or more waypoints, including an observed waypoint and at least one goal waypoint, wherein the multiple basis paths are generated by fitting one or more splines between the observed waypoint and one of the goal waypoints of the graph representation.

The scenario inputs may comprise at least one trajectory prediction. The scenario inputs may comprise a likelihood of collision associated with the at least one trajectory prediction.

The method may be applied to generate a predicted trajectory for a non-ego agent, wherein the predicted trajectory is passed to a planner for planning a trajectory of an ego vehicle.

The scenario may comprise one or more further agents, wherein the trajectory generation comprises generating a respective predicted trajectory for the agent and each of the one or more further agents.

The method may comprise generating estimated likelihoods for one or more goals and/or motion profiles of each of the agent and the one or more further agents, wherein the scenario inputs comprise the estimated likelihoods.

The method may be applied to plan a trajectory for an ego agent, wherein the trajectory generation comprises generating a candidate planned trajectory for the agent.

The candidate planned trajectory may be used to seed a runtime optimizer that generates a final planned trajectory for the agent.

The candidate and/or final planned trajectory may be used to generate control signals for controlling an actor system of the ego agent.

In a simulation context, the control signals may be input to an ego vehicle dynamics model to simulate the planned behaviour of the ego agent.

The trajectory generation may further comprise generating one or more spatial uncertainty distributions for the agent, wherein each spatial uncertainty distribution provides a measure of the likelihood of the position of the agent at a given time.

The generated trajectory and spatial uncertainty distributions may be generated for each of a set of equally spaced timesteps.

The spatial uncertainty distributions may be elliptical Gaussian distributions.

The trajectory generation may comprise generating a trajectory for each of a predefined number of modes, wherein the method may further comprise generating a mode prediction indicating a most likely mode for the agent.

The method may further comprise a collision assessment step comprising computing a likelihood of collision for each agent of the scenario based on the generated trajectories for all agents.

The collision assessment step comprises computing a collision probability for the agent by evaluating an overlap between a predicted occupied region of the agent at a given timestep and the generated spatial uncertainty distribution of each further agent at the same timestep.

The collision assessment probabilities and generated trajectories may be provided to a further neural network configured to generate trajectories for the agents of the scenario.

Another aspect herein provides a method of training a neural network for generating a trajectory for an agent, the network comprising a set of network parameters, the method comprising: receiving a set of training data comprising a set of training inputs, each input comprising an observed state of an agent and an indication of a road layout, and a set of corresponding ground truth outputs, each ground truth output comprising an actual trajectory taken by the agent from the observed state; generating a set of multiple trajectory basis elements from the observed state of the agent based on the road layout; processing the training inputs in the neural network to generate a set of weights, each weight corresponding to one of the trajectory basis elements; and generating a trajectory for the agent by weighting each trajectory basis element by its corresponding weights and combining the weighted trajectory basis elements; computing an update to the parameters of the network based on a loss function that penalises deviations between the generated trajectory and the corresponding ground truth output for the agent.

The training data may comprise historical trajectories taken by agents in past scenarios, wherein the trajectories are generated in training from a past observed state.

The training data may comprise a planned agent trajectory generated by a reference planner, the reference planner also having planned from the observed state.

A trajectory may be generated for each of a predefined number of modes, wherein the loss function penalises deviations between the ground truth and the generated trajectory which is most similar to the ground truth only.

The network may be configured to generate a spatial uncertainty distribution associated with the generated trajectory, wherein the loss function encourages spatial uncertainty distributions that assign a high likelihood to the ground truth trajectory.

The network may be further configured to generate a mode prediction indicating a probability that each mode is the optimal mode, and wherein the loss function encourages a high probability for the mode whose trajectory is most similar to the ground truth trajectory and a low probability for the mode(s) whose trajectories are less similar to the ground truth trajectory.

The observed state may comprise a position and a velocity of the agent at an initial timestep.

Basis trajectory elements may be determined using predictable geometric computations and/or motion models.

Another aspect herein provides a computer-implemented method of generating a future path for an agent in a scenario, the method comprising: determining a plurality of basis paths, each determined as a spline fitted to a set of waypoints, and using a neural network to generate a trajectory for the agent based on one or more inputs pertaining to the scenario, as a weighted combination of the basis motion profiles, wherein the neural network computes a set of weights for computing the weighted combination.

The most ‘extreme’ output in this case is the selection of one basis splines.

Another aspect herein provides a computer-implemented method of generating a future motion profile for an agent in a scenario, the method comprising: using one or more physics-based motion models to generate a plurality of basis motion profiles for the agent, and using a neural network to generate a trajectory for the agent based on one or more inputs pertaining the scenario as a weighted combination of the basis motion profiles, wherein the neural network computes a set of weights for computing the weighted combination.

Examples of physics-based motion models include constant velocity (CV), constant acceleration (CA), Constant Turn Rate and Acceleration (CTRA), kinematic bicycle etc., which may for example be applied to one or more current and/or historical states of the agent.

A further aspect herein provides a computer system comprising computer memory and one or more processors configured to carry out any method disclosed herein. A further aspect herein provides a computer program for programming one or more computers to implement any method disclosed herein.

The term ‘map data’ is used broadly, and extends to both ‘online’ and ‘offline’ mapping, or any combination thereof. Offline mapping refers to a process whereby the area in question has been mapped in advance. For example, in an autonomous driving context, offline map data could be provided in one or more high-definition maps of the area that have been carefully produced to centimetre accuracy. Online mapping includes the use of perception method(s) to map the area in real-time, e.g. using sensor data collected from an autonomous vehicle's onboard sensors (or some suitable proxy in simulation). Such techniques include image-based mapping and lidar mapping.

A basis trajectory element could be a basis trajectory including spatial and motion components. In this case, the trajectory is generated as weighted combination of basis trajectories (each including a spatial component and a motion component). Alternatively, separate path and motion profile basis elements may be used. In that case, a path component of the trajectory is determined as a weighted combination of basis paths, and a motion component of the trajectory is determined as a weighted combination of basis motion profiles.

In the described embodiments, a neural-network-based method is provided for predicting a set of future trajectories for a plurality of agents in a scenario (scene), given the state of the agents at a current point in time, with the future trajectories defining the state of each agent over a sequence of future timesteps. The described method uses one or more trained neural networks in the prediction of trajectories, including a neural network that learns to predict, for each agent, a set of weights that may be applied to generate a predicted trajectory comprising a path and motion profile, computed as a weighted sum of a set of basis paths and motion profiles determined from the current state of the agent. The basis paths and motion profiles are determined based on map information of the scene, such that the road layout informs the possible trajectories of the agents. This method enables the use of neural networks without the risk of generating unexpected or dynamically unfeasible trajectories, since a weighted combination of basis paths or motion profiles is constrained to be no more extreme than any individual basis path or motion profile at each time or distance step in the scenario. This allows the neural network to work within the safety standards required of prediction and planning systems for autonomous vehicles.

The trajectory generation network described below may also be used as part of a planner for an autonomous vehicle stack in order to plan actions for the autonomous vehicle (referred to herein as the ego vehicle) that take into account the expected trajectories of the other agents of the scene. A two-stage planner may use a neural network to generate a set of weights to be applied to a set of basis paths and motion profiles for a given goal of the ego vehicle to generate an initial planned trajectory, which can be used to seed a second stage that performs non-linear optimisation.

Example embodiments will not be described by way of example only, with reference to the accompanying figures.

### BRIEF DESCRIPTION OF FIGURES

To assist understanding of the present invention, and to show how embodiments of the same may be carried into effect, reference is made by way of example only to the accompanying drawings, in which: FIG. 1 shows a schematic block diagram of autonomous vehicle runtime stack;

FIG. 2 shows a prediction system for generating predicted trajectories for a plurality of agents;

FIG. 3 shows a schematic block diagram of a trajectory generation network;

FIG. 4 shows the training of a trajectory generation network;

FIG. 5 shows an example set of basis paths from which a predicted path is generated;

FIG. 6 shows an example implementation of a trajectory generation network in a planning system;

FIG. 7 shows a visualisation of spatial uncertainty distributions predicted by a trajectory generation network;

FIG. 8 shows an example collision assessment between trajectory predictions of two agents.

### DETAILED DESCRIPTION

To provide relevant context to the described embodiments, further details of an example form of AV stack will now be described.

FIG. 1 shows a highly schematic block diagram of an AV runtime stack 100. The run time stack 100 is shown to comprise a perception (sub-)system 102, a prediction (sub-)system 104, a planning (sub-)system (planner) 106 and a control (sub-)system (controller) 108. The term (sub-)stack may also be used to describe each of the aforementioned components 102-108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

Note, there may be a distinction between a planned trajectory at a given time instant, and the actual trajectory followed by the ego agent. Planning systems typically operate over a sequence of planning steps, updating the planned trajectory at each planning step to account for any changes in the scenario since the previous planning step (or, more precisely, any changes that deviate from the predicted changes).

In a real-world context, the planning system 106 and other components of the AV stack of FIG. 1 may be implemented as components on-board a vehicle. When applied for testing the performance of an AV stack, the planning system 106 may be applied offline in simulation to plan a trajectory for a simulated ego vehicle in one or more simulated scenarios, and the behaviour of the ego vehicle and other agents of the scenario may be simulated based on outputs of the planning and prediction stacks and vehicle dynamics models. References herein to planning and prediction for ego and other agents refer to prediction and planning of trajectories in both a real-world context, in which a prediction component on-board an autonomous vehicle determines in real-time the likely behaviour of agents in a scenario, and where an on-board planner generates a suitable trajectory for the ego vehicle, which is executed by sending control signals to an actor system which controls the vehicle, and in a simulation context, in which a set of possible agent trajectories can be generated by a prediction component running offline on a simulated scenario, and where the ego trajectory is generated by an offline planner and executed in simulation using a behaviour model.

The planning system 106 may reason into the future, such that the planned trajectory at each planning step extends beyond the next planning step. Any individual planned trajectory may, therefore, not be fully realized (if the planning system 106 is tested in isolation, in simulation, the ego agent may simply follow the planned trajectory exactly up to the next planning step; however, as noted, in other real and simulation contexts, the planned trajectory may not be followed exactly up to the next planning step, as the behaviour of the ego agent could be influenced by other factors, such as the operation of the control system 108 and the real or modelled dynamics of the ego vehicle). In many testing contexts, the actual trajectory of the ego agent is what ultimately matters; in particular, whether the actual trajectory is safe, as well as other factors such as comfort and progress. However, the rules-based testing approach herein can also be applied to planned trajectories (even if those planned trajectories are not fully or exactly realized by the ego agent). For example, even if the actual trajectory of an agent is deemed safe according to a given set of safety rules, it might be that an instantaneous planned trajectory was unsafe; the fact that the planner 106 was considering an unsafe course of action may be revealing, even if it did not lead to unsafe agent behaviour in the scenario. Instantaneous planned trajectories constitute one form of internal state that can be usefully evaluated, in addition to actual agent behaviour in the simulation. Other forms of internal stack state can be similarly evaluated.

It will be appreciated that the term “stack” encompasses software, but can also encompass hardware. In simulation, software of the stack may be tested on a “generic” off-board computer system before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

Components of an AV stack as described herein, including prediction and planning systems may be implemented as part of a reference stack, which can be used for comparison with an external AV stack for performance testing of that external stack. For example, a planner system 106 as described herein may be provided as a reference planner in order to test the performance of another planner which may be implemented, for example as a runtime planner for an autonomous vehicle. The overall performance of the AV stack described herein may be compared with that of an external stack on the same real or simulated scenarios in order to provide a relative measure of performance for that external stack.

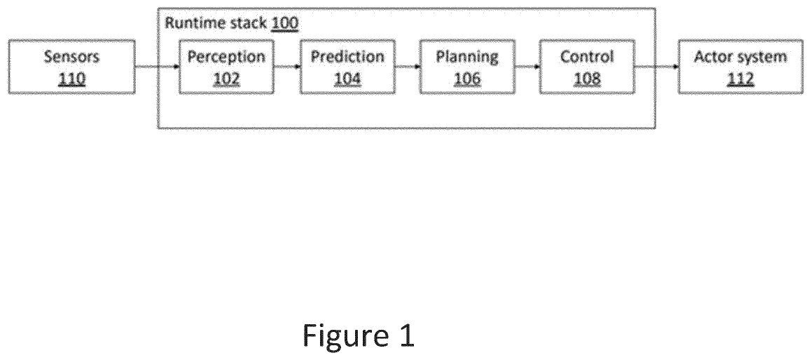

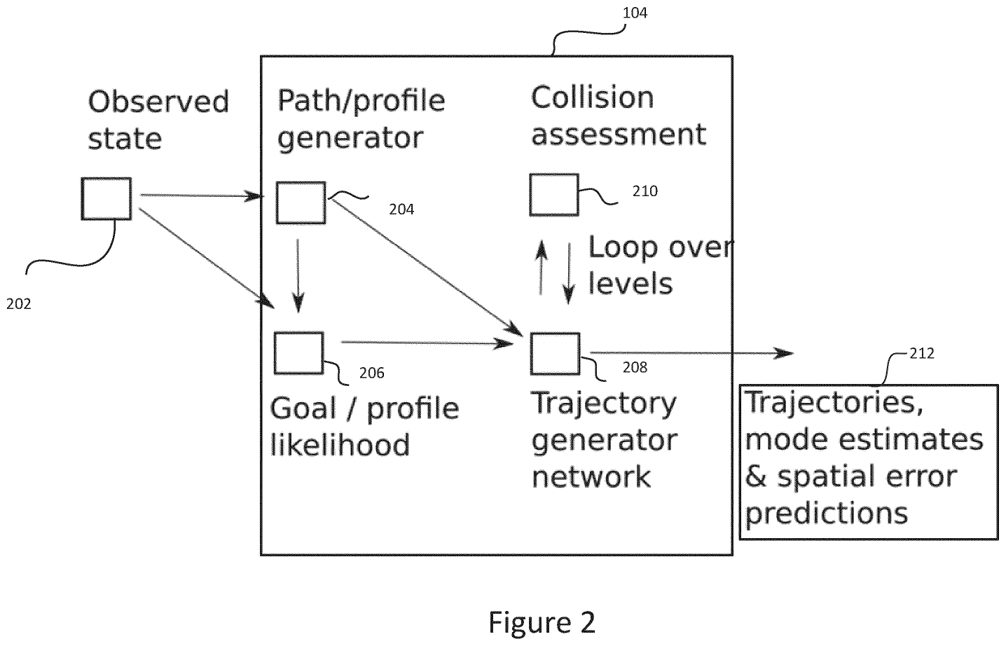

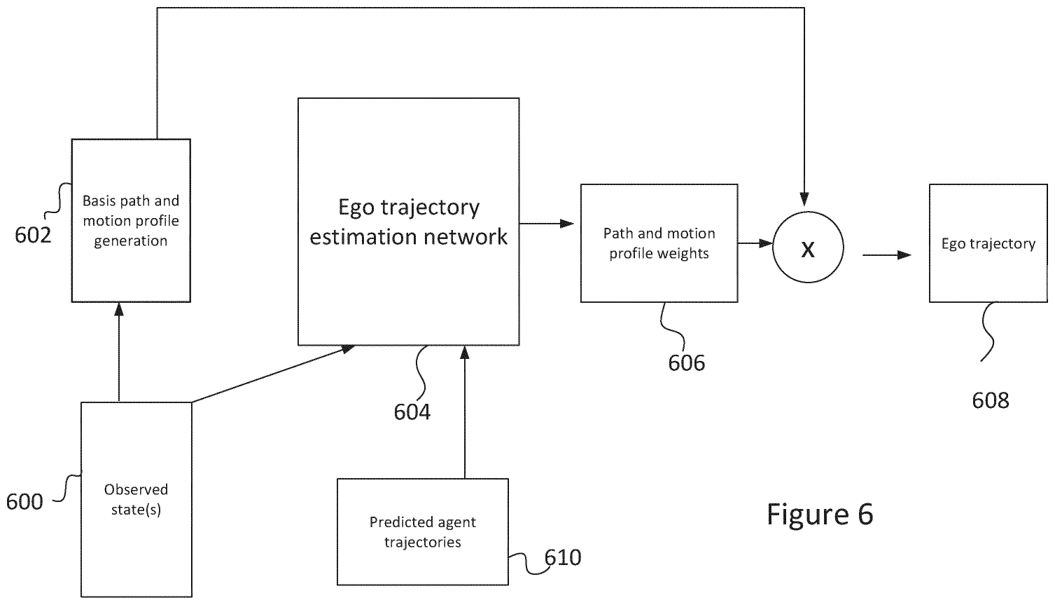

Described below with reference to FIGS. 2-5 is an implementation of a neural network to generate trajectories as a weighted sum of basis trajectories. The below description is directed to a prediction application, as implemented for example by the prediction system 104, where a set of predicted future trajectories is generated for the one or more agents in the scenario, based on which the AV stack may perform planning and other functions. However, as described later, with reference to FIG. 6, the generation of trajectories based on a set of basis elements is applicable to more than prediction, and can also be used, for example to plan realistic trajectories for an ego agent.

FIG. 2 gives an example implementation of the present invention wherein a prediction system 104 utilises a trajectory generator network 208 to predict a set of weights defining a trajectory as a combination of basis paths and motion profiles. The examples described refer to predictions for vehicles driving on a road, but it is noted that the methods described may also be used to predict trajectories of other types of agents, such as pedestrians, cyclists etc.

As shown in FIG. 2, the system 104 receives an observed state 202 for the scene defining the position and motion of the agents. For example, the state may include the position of each agent in the scene with position coordinates (x,y) and a yaw angle indicating the orientation of the agent's path with respect to the forward direction, as well as a kinematic state with a velocity, acceleration and jerk. Multiple observed states may be received comprising the state of the scene over a past time interval in addition to the most recent state from which the system is predicting the trajectories. In addition to the state of the agents, the observed state comprises information describing the static elements of the scene, such as the road and lane boundaries, and road features such as junctions and roundabouts. This information may be derived from a map of the scenario region or from sensor data such as camera images, lidar, radar, etc. The static scenario information and states of the agents are passed to a path/profile generator 204, that generates a set of paths (i.e. a set of spatial coordinates along which a given agent might move) and motion profiles (i.e. the kinematic state of the agent along the given path, defining the speed and acceleration of the agent along the path at each timestep).

The path/profile generator 204 determines a set of basis paths for a single agent from a given starting position and starting timestep as follows. This may be the timestep corresponding to the most recently observed state. First a set of possible goals are generated for the agent. Goals can be identified by constructing a graph representation of a drivable region, for example, a section of road up to a predefined distance. The graph may comprise a set of waypoints along the centre of each drivable lane of the road. In a highway example, the drivable region comprises three lanes, with a single direction of traffic, and the graph representation comprises waypoints along three lines at the centre of each lane of the highway. All graph traversals from a given starting point along a specific distance of road can be traversed, and a final waypoint at each lane of the road can be maintained as a goal waypoint. Thus, for a starting point in the centre of the leftmost lane and an example distance of 200 m, the possible goals are (a) to follow the current lane, corresponding to a goal waypoint in the leftmost lane, (b) to change to the centre lane, performing a lane change at some point along the 200 m of road, this goal corresponding to the goal waypoint at the end of the given section of the centre lane, or (c) to move into the rightmost lane, thereby changing lanes twice, with this goal corresponding to a goal waypoint 200 m ahead in the right lane. A goal is defined for all lanes for which a graph traversal is possible from the given starting point, so for example at junctions and roundabouts, a goal is defined for all possible turns and/or exits.

A goal waypoint may also be defined outside of the road layout, representing a continuation of an existing agent behaviour. For example, where the current state, and optionally one or more historical states, of a given agent indicates that the agent is veering off the road represented by the lane graph, a goal representing the continuation of the agent's current trajectory at its current velocity, or the continuation of the agent's current path at a current acceleration/deceleration and/or curvature may be generated by defining a waypoint for that goal, as well as a target kinematic state, and fitting splines to the respective waypoints, thereby generating an additional basis path and motion profile for behaviours outside of the road layout.

A set of basis paths are generated for the goals generated as described above by fitting one or more splines between waypoints of the graph, where the splines extend between waypoints from the starting point to the respective goal waypoint, where the splines may also be fit via one or more intermediate waypoints. More than one basis path may be generated to the same goal waypoint, each representing a different behaviour of the agent. For example, where the goal waypoint is in a neighbouring lane to the start point, such that a lane change is necessary, one possible basis path may complete the lane change over a short distance, while another basis path may perform a longer lane change such that the path moves between the two lanes for a longer distance.

One possible type of spline that may be used to fit the waypoints of the graph is a Bezier spline. Each basis path is defined as a set of position coordinates (x, y, yaw) of the agent along a plurality of evenly spaced distance steps along the spline. Alternatively, only (x, y) coordinates may be defined at each step, where the yaw angle can be derived based on the tangent of the path at the given step.

A set of motion profile targets can be generated by identifying a number of target kinematic states, which are defined based on the road speed at each goal, as well as a number of motion profile parameters representing behaviours, such as acceleration and relative speed. The motion profile target specifies the final speed and acceleration of the agent at the respective goal. Basis motion profiles are produced by fitting speed profiles between the initial and target kinematic states using splines. Bezier splines may also be used for generating the basis motion profiles in this way. The basis motion profiles are defined as a set of motion coordinates, such as speed, acceleration and jerk, at each of a set of equally-spaced timesteps up to the motion profile target.

The set of possible goals are passed to a goal/profile likelihood estimator 206, and the basis paths and motion profiles are passed to the trajectory generator network 208.

The goal/profile likelihood estimator 206 generates a set of likelihoods for the possible goals and a set of likelihoods for possible motion profiles associated with those goals. The goal and motion profile likelihood estimation is performed using inverse planning. Inverse planning generates a set of proposed paths and motion profiles for each goal from a starting state in the past, and extending over a historical time period. The resulting paths and motion profiles are then compared with the trajectory actually taken by the agent from that starting state in order to generate a likelihood for the proposed goals and motion profiles. Inverse planning is described in further detail in International Patent Publication No. WO 2020/079066, as well as United Kingdom Application No. 2200416.2, both of which are hereby incorporated by reference in their entirety.

The goal and motion profile likelihood estimation may be implemented as a neural network, where the network outputs a set of likelihood values corresponding to the proposed goals and motion profiles, and where the network is trained using a classification loss function, such as cross entropy loss, that encourages the network to assign a high likelihood to goals and motion profiles corresponding to the trajectory closest to the actual historical trajectory and a low likelihood to all other goals and motion profiles. Alternatively inverse planning may be implemented by other methods, such as a Rapidly Exploring Random Tree (RRT) model. This method is described in International Patent Publication No. WO 2020/079066.

The goal and profile likelihood estimator determines the most likely goals and motion profiles for agents of the scenario, which are used to inform the trajectory generator network 208 of an appropriate weighting of the basis paths and motion profiles defining the agent's trajectory. For example, in the case where an agent's current state is beginning to move off the road, as described above, a goal is defined representing the intention of that agent to maintain its current course and continue moving away from the road, while another possible basis path leads the agent from its current state back to the road layout, that path ending in a goal waypoint derived from the lane representation. For initial agent states further from the road layout, the goal and profile likelihood estimator assigns a higher probability to the off-road goal and a lower probability to goals wherein the agent returns to the road layout. These relative likelihoods of the respective goals are then provided as input to the trajectory generation network 208, which uses the relative likelihood to determine a contribution of the basis paths and motion profiles associated with the respective on-road and off-road goals to the final predicted trajectory of the agent. Therefore, although a set of basis paths are always generated from the road layout, in cases where the agent has moved off-road, the weighting determining the predicted path of the agent may be biased heavily towards the basis paths generated from the current and past states of the agent only, rather than those paths derived from the lane representation of the road layout.

The trajectory generator network 208 receives the goal and motion profile likelihood estimations from the goal/profile likelihood estimator 206 as well as the set of basis paths and basis motion profiles from the path/profile generator 204, and the observed states 202 of the scene, which includes historical states of the scene extending over some past time interval and the current state of all agents of the scene, and may also include the road layout.

The trajectory generator 208 is implemented as a multi-layer neural network, which processes each of these inputs and outputs a set of weights defining a relative weighting of the basis paths at each distance step, as well as a weighting of the generated motion profile at each timestep up to the motion profile target. The weighting is applied by multiplying the basis paths and motion profiles by their corresponding weights and combining the resulting path and motion profile into a single trajectory for the given agent by deriving distances from the motion profile and interpolating the path such that the position and motion of the agent is defined for each timestep from the starting point until the time the agent reaches the end of the predicted path. It should be noted that instead of generating a separate weighting for the basis paths and the basis motion profiles and then combining them to form a predicted trajectory, a set of basis trajectories may instead be generated by the path/profile generator 204 and a set of weights predicted for the basis trajectories to combine them into a predicted trajectory in the output 212.

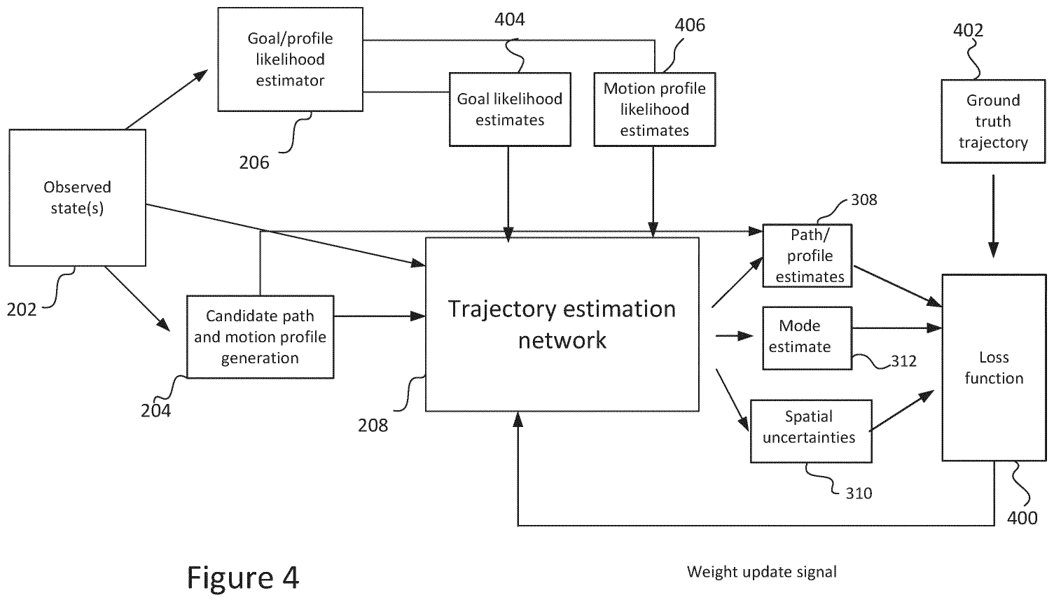

The trajectory generator network 208 is configured to generate a separate set of weights defining a separate trajectory for each of multiple prediction modes, where the number of prediction modes is specified in advance. The network 208 is trained based on a loss function comprising a term to penalise deviations between the predicted trajectory obtained by interpolating the paths and motion profiles as described above and a ground truth trajectory taken by the agent over the same period. This may be achieved, for example, by performing the trajectory prediction from a past state, such that a ground truth trajectory is the actual trajectory taken by the agent in a time interval immediately following that past state. The loss function selects the trajectory for the ‘closest’ or most similar mode, i.e. the mode whose trajectory is closest to ground truth, and computes the deviation of that trajectory from the ground truth trajectory, based on which the network weights are updated. This encourages the network to learn predicted trajectories close to the actual trajectories of the agents, but allows the network to provide multiple different predictions for different modes. Further details of training are provided below, with reference to FIG. 4.

In addition to the predicted trajectory for each prediction mode, the output 212 of the trajectory generation network 208 also comprises a set of spatial uncertainties associated with each trajectory at each timestep. The spatial uncertainties may be in the form of elliptical Gaussian functions oriented on the yaw angle of the trajectory. The trajectory generator network additionally outputs an estimated probability for each prediction mode. The loss function used to train the trajectory generator network may also include a term to maximise the probability of the ‘ground truth’ mode, i.e. the mode whose trajectory corresponds most closely to the ground truth trajectory, and a term to encourage a high likelihood of the ground truth trajectory according to the spatial uncertainty distribution.

A collision assessment module 210 computes a likelihood of collision between the different possible trajectories computed by the network 208. The processing of the trajectory generator network is performed over multiple levels of prediction, where at an initial level (also referred to herein as level-0 prediction), the trajectory estimate produced is based on the position and kinematic state of the agent and the static position of the other agents of the scene, but does not consider any future motion of the other agents. However, a collision assessment 210 performed on the output of the level-0 prediction is used in a subsequent level of prediction, referred to herein as level-1 prediction. The collision assessment comprises computing a probability of overlap between the predicted position of the agents, including the predicted spatial uncertainty with an occupied region of each agent, represented as an ellipse with equal area and proportion as the rectangular occupied region of the agent (where in this example the agent is a vehicle). The implementation of higher levels of prediction is described in more detail later.

The trajectory generator network uses the ground truth trajectory of each agent to update the weights of the network at each level of prediction. This training is described in more detail below, with reference to FIG. 4.

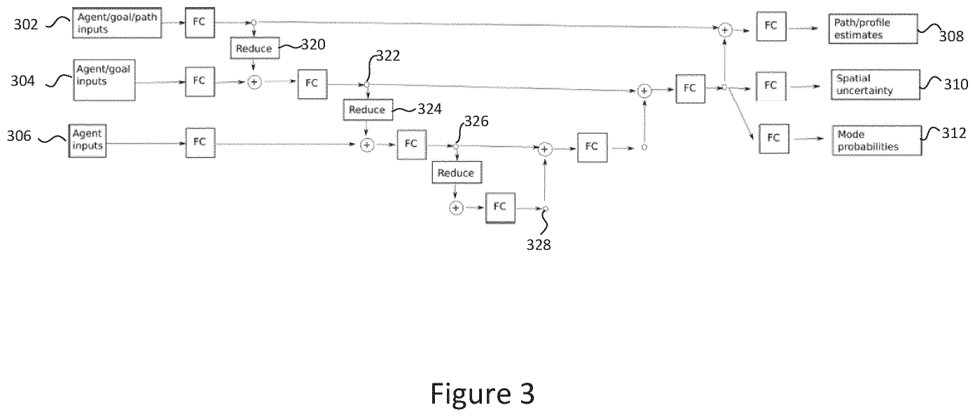

The inputs to the network may have different dimensionalities. For example, the set of basis paths is defined for each agent of the scene, and comprises a set of spatial coordinates for each waypoint, while the observed states define spatial and motion information for each agent over a set of past timesteps. The multiple inputs are handled by the network by processing each input type by one or more fully connected layers and reducing the results to generate a context representation for the scene. This is shown in FIG. 3.

The inputs to the network can include inputs that have values for each agent, goal and path. For example, position coordinates are defined for each basis path, where the basis paths as described above are generated for each agent, and where each basis path is associated with a proposed goal. As described above, the paths are generated for each goal based on possible paths to that goal waypoint via the points defined for the lane graph of the drivable region, and therefore the number of paths is variable for different scenarios, agents and goals. In order to process a variable-size input in a neural network, which is configured to receive inputs of a predefined size, a pre-processing step is necessary to generate a standardised representation of the input of a constant dimension. Other inputs may be defined per agent and goal, such as the goal likelihood estimates produced by the goal/profile estimator 206.

This is shown in FIG. 3, which shows an example architecture for a trajectory generation network with three input dimensionalities: agent/goal/path inputs 302 which comprise a value for each path, goal and agent, agent/goal inputs 304 which comprise a value for each agent and goal, and agent inputs, which provide a value for each agent (for example a current position of the agent). The trajectory generator network 208 processes all inputs together by reducing higher dimensional inputs in turn and combining them. First, the agent/goal/path inputs 302 and the agent/goal inputs 304 are modified by applying a fully connected layer to each to produce feature representations for each. The agent/goal/path representation has a dimension for the path that is not present in the next level of the hierarchy, and so this representation is reduced (320) along the path dimension to generate a representation matching the dimension of the representation generated at the agent/goal layer and the reduced agent/goal/path representation and the agent/goal feature representation, each of which has agent and goal dimensions, are combined to a single representation of the agent/goal inputs. The reduction may be performed, for example, by computing a sum, mean, max of the feature representation elements for each goal and agent over all the paths, in order to generate a scalar value for each path, giving a representation with agent and goal dimensions which can be combined with the existing agent/goal inputs 304.

The agent inputs 306 and agent/goal combined representation are then processed by respective fully connected layers and the resulting agent/goal representation 322 is similarly reduced (324) to generate further lower-dimensional representations at the agent level. The reduced representation resulting from the reduction 324 is combined with the representation of the agent inputs 306 to produce a representation at the agent level. This representation provides features for each agent representing the inputs corresponding to that agent. A fully connected layer is applied to the combined representation to generate an overall agent-level representation 326 of all the inputs.

The number of agents is variable for each scenario. A standard representation of the entire scenario with all agents can be generated by reducing the agent-level representations 326 along the agent dimension, for example by computing a mean representation over all agents, and a fully-connected layer is applied to the result to generate an overall context representation 328. This method is similar to the concept of word embeddings, in which a network reduces a text input to a low-dimensional vector representation that retains the meaning of the original text.

To generate the outputs 212, the overall context representation 328 describing the entire scene is added as context to the representations generated for each of the inputs at each layer of dimensionality, and these are processed with further fully connected layers in order to generate the set of outputs, where the mode probabilities 312, path/profile estimates 308 and corresponding spatial uncertainties 310 are defined for each agent and prediction mode. The representations added at each level from the lower-dimensional levels may be combined with the higher-dimensional representations by broadcasting the lower-dimensional representation across the additional dimension, such that the two representations match, and then combining the two representations, for example by summing the two representations, or concatenating them.

The path/profile estimates 308, as described above, are output as a set of predicted weights corresponding to each distance step of the basis paths and each time step of the basis motion profiles. The weights are applied to weight each of the basis paths defined for each agent, and the basis motion profiles defined for each agent, in order to generate a full predicted trajectory. It should be noted that, while each basis path and each basis motion profile is associated with a specific goal, the output of the network is not necessarily associated with any single goal. The full set of basis paths and motion profiles generated for all proposed goals of the given agent are used in the weighting of the final predicted path. The weights are normalised to add to one, such that they define a relative contribution of each basis path and basis motion profile to the trajectory, ensuring that the predicted paths and motion profiles at each distance or time step is not more extreme than any single basis path or motion profile. The most ‘extreme’ weighting at any given step assigns a weight of 1 to a single basis path or motion profile, and a weight of 0 to all other paths or motion profiles. This step of generating the trajectory is not shown in FIG. 3, but where a path/profile or trajectory estimate or prediction is referred to herein, it should be noted that it is defined by the set of weights predicted by the network in combination with the basis paths and motion profiles generated by the path/profile generator 204.

FIG. 4 shows a schematic block diagram of the training of the trajectory estimation network 208. The trajectory estimation network comprises multiple fully connected ‘hidden’ layers, each ‘hidden’ layer comprising a set of ‘neurons’, where a neuron comprises a nonlinear function, often referred to as an activation function. The activation function may be, for example a logistic sigmoid function, or a rectified linear unit. These functions are well known in the field of machine learning and will not be discussed further herein. The input to each neuron is a weighted sum of the input to the given layer. A layer is described as ‘fully connected’ when the full input to the layer is processed by every neuron of that layer. The weights of the connections between the input layer and each neuron, and between neurons of consecutive hidden layers, are parameters of the neural network model, and these weights are updated in training to encourage the neural network to learn to perform the desired task, which in the present application is a prediction of agent trajectories.

The trajectory generator network 208 is trained by starting with a random initialisation of weights, and processing the inputs as described above with reference to FIG. 3 to produce predicted trajectories. To update the weights, a loss function 400 penalising deviations between the predicted trajectories and the ground truth trajectories of the corresponding agents is evaluated, and an update signal is generated for the weights. This may use a form of gradient descent, wherein the weights are updated in the direction of the negative gradient of the loss function with respect to the weights. Gradient descent methods are well known in the field of machine learning for training neural networks and will not be described in detail herein.

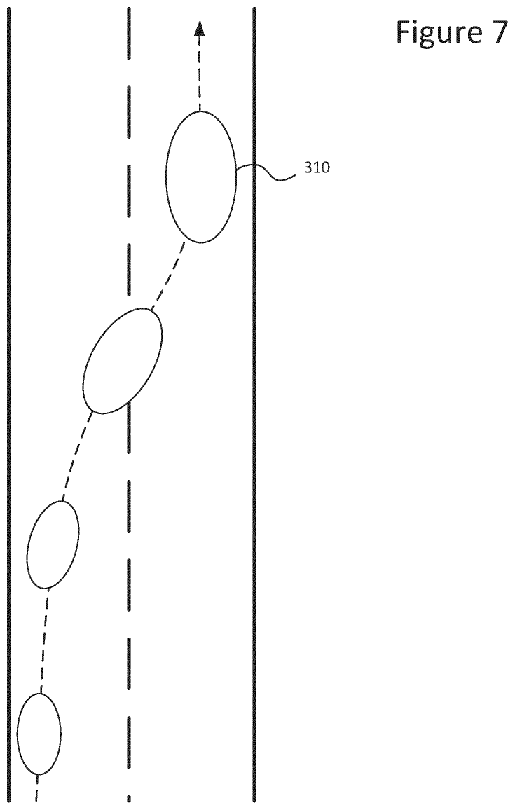

As shown in FIG. 4, the observed state of the scene 202 is passed to both a basis path and motion profile generator 204 which generates a set of basis paths and motion profiles and a goal/profile likelihood estimator 206, which produces a set of goal likelihoods and a set of motion profile likelihoods. The basis paths and motion profiles, goal likelihoods 404, motion profile likelihoods 406, and the observed state 202 of the scenario are passed to the trajectory estimation network 208, which reduces and processes the inputs as described above with reference to FIG. 3, generating a set of predicted path and motion profile weights. The resulting predicted path and motion profile weights are applied to respective basis path and motion profiles to generate predicted trajectories as defined by path and profile estimates 308 for each agent and prediction mode, as well as a mode probability estimate 312, and a spatial uncertainty 310, which may be in the form of parameters defining an elliptical Gaussian function. An example of a spatial uncertainty produced by the trajectory estimator 208, is shown in FIG. 7.

The loss function 400 is defined to encourage the network to learn to predict trajectories that are close to the ground truth trajectories in training. As mentioned above, training may be performed using a training dataset for which the actual trajectories of the agents from a selected starting point in a given scene is already known, where the prediction system is provided with the state of the system up to that starting point from which to make a prediction. The actual trajectories are provided in training as ground truth 402 for computing the loss function. As mentioned above, the loss function may comprise multiple terms associated with the multiple outputs of the network.

The output comprises path and profile estimates 308 (i.e. basis path and motion profile weightings defining trajectories) and spatial uncertainty 310 for each mode, as well as a probability 312 for each mode. A goal of the network 208 is to predict with high probability the best mode, as well as to predict a trajectory for that mode that is close to the actual trajectory taken by the agent. The loss function may therefore simultaneously encourage the probability of the mode closest to the ground truth trajectory to be maximised, and encourage a measure of distance between the predicted trajectory of the best mode and the ground truth trajectory 400 to be minimised, as well as maximising the likelihood of the ground truth trajectory according to the predicted spatial uncertainty distribution. Once the loss function 400 is computed for a given set of training data, an update signal is passed back to the network, and the weights are updated according to the update signal. The update algorithm may use gradient descent, in which the update signal comprises a gradient of the loss function, such that the weights are updated in a direction that minimises the loss. Multiple rounds of updates are performed to iteratively improve the predictions output by the network.

As mentioned above, the trajectory generation network 208 does not directly output a predicted trajectory, i.e. a set of position and motion values defining the agents' motion, but instead produces a set of weights to be applied to basis paths and motion profiles generated earlier by the path/motion profile generator 204, described above. However, the loss function 400 is applied to the trajectory generated by applying the weights to the basis paths and motion profiles. As mentioned, this uses map information to generate a set of possible paths within a graph of a drivable region of road and fits both the path and the motion profile to the start and target states for the given goal by fitting splines between points in the graph and between the initial kinematic state and the motion profile target. A relative weighting of these paths and motion profiles ensures that the output of the trajectory estimation network is not more extreme at any given point than the basis paths and motion profiles themselves.

The description above describes steps of a ‘level-0’ prediction, where the set of inputs includes only current and past states of the agents of the scene, without consideration of the future motion of other agents of the scene when generating a trajectory for a given agent. Once a set of trajectories is generated at this level, however, these predictions can be used as input to a second layer of trajectory generation that takes into account the expected motion of the agents from the level-0 prediction. Additionally, a collision assessment is performed on the predictions output at level-0. As described above, the collision assessment 210 determines a probability of collision between agents in the scenario by evaluating a degree of overlap of the spatial uncertainty distributions output by the trajectory generation network for a given agent and the occupancy region of other agents, represented as an ellipse.

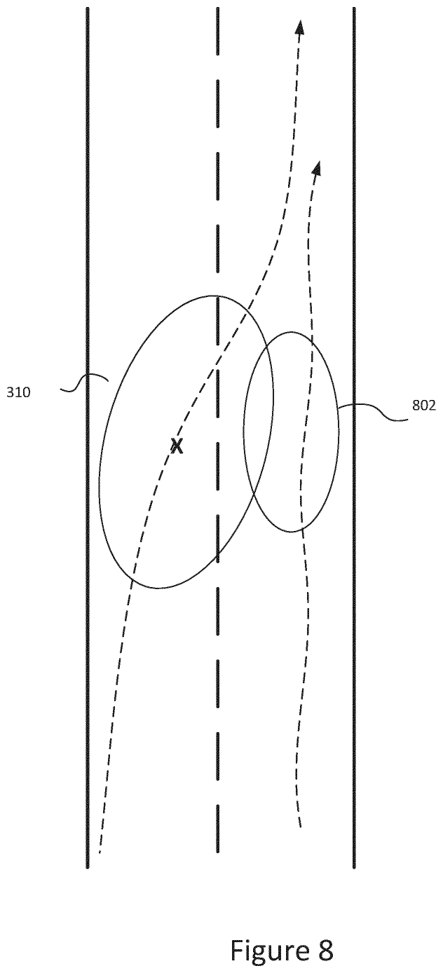

The collision probabilities compute a degree of overlap between all predicted trajectories, considering all modes for each agent, where the collision probability for a given agent is computed by weighting the likelihood of overlap between specific trajectories and the estimated probability of the respective modes that the given trajectories are associated with. A simplified example of this is shown in FIG. 8, where a spatial uncertainty distribution 310 around a predicted position of an agent moving into the right lane is used to compute a probability of collision by evaluating the overlap of the agent in the right lane, represented by an ellipse 802, with the spatial uncertainty distribution of the other agent's position. For each agent, the probability of collision is assessed against all other agents of the scenario and possible trajectories, and an overall probability of collision with any other agent is computed for that agent's trajectory at that timestep. As any given agent has a number of modes, a separate collision assessment is performed for each mode, i.e. for each agent trajectory. However, the probability of collision for any given agent and mode is aggregated over all possible external agent trajectories. The result of the collision assessment is a matrix of probabilities of collision for each agent and mode at each timestep, i.e. a matrix of dimension agents×modes×timesteps.

At the next level of prediction, a trajectory generation network receives as inputs: the observed state of the system, the goal and motion profile likelihoods and the basis paths and motion profiles, as described in FIG. 3 for level-0 prediction, in addition to the outputs of the level-0 prediction, i.e. the generated trajectories, mode probabilities and spatial uncertainties output by the trajectory generation network 208. The basis paths, motion profiles and goal and motion profile likelihoods may be re-computed at level 1, or alternatively the same basis paths and motion profiles that were generated for input to the level-0 network may be used as input for level 1. The level-1 network also receives the collision assessment results based on the evaluation of the predicted trajectories and uncertainty distributions from level-0 prediction.

The level-1 trajectory generation network is configured with a slightly different architecture in order to receive these inputs and reduce the representations of the collision assessment inputs and the previous level's predictions with the basis paths and motion profiles and likelihood estimations to reduce the overall representation of the input to a single context representation. For example, the collision assessment output, described above, has dimension agents×modes×timesteps. This is treated as an agent input 306, that has a variable agent dimension, and the modes and timesteps matrix for each agent is appended to the other agent inputs in order to generate the agent representation. The output of the level-1 trajectory generation network is identical to the output of the level-0 trajectory generation network, comprising, for each agent, a set of predicted trajectories with associated spatial uncertainties, as well as a probability for each prediction mode. The level-1 trajectory generation network is also trained by the method described above, using a loss function to encourage the network to predict trajectories close to the actual ground truth trajectory taken by the agent.

The prediction may be performed over multiple successive levels, including level-2, level-3, etc., in order to further refine the predictions based on the interactions between the agents' respective predicted trajectories. Each level uses a different network trained with its own parameters to perform different levels of interactive trajectory generation. However, the form of the input from level 1 onwards is identical, comprising the observed state, basis paths and motion profiles, goal and profile likelihood estimations, and the previous level's predictions and collision assessment results. Therefore, from level 1 onwards all networks share an architecture, although each is trained separately, and therefore learns different network parameters.

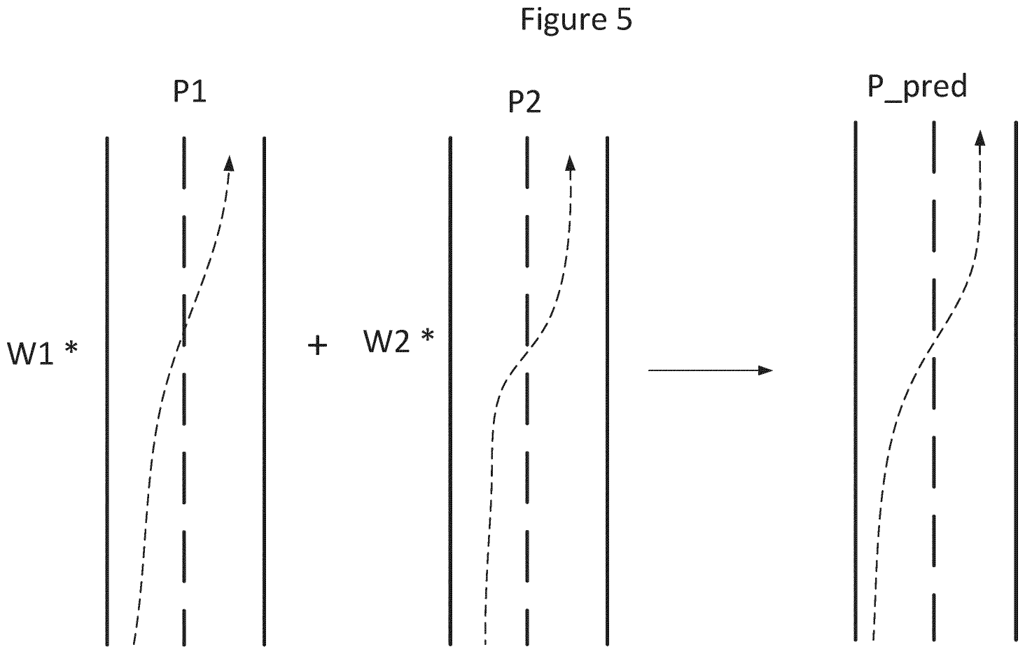

FIG. 5 shows a highly simplified example of a path generated by interpolating a set of two basis paths computed from a starting state in the left lane of a two-lane road section towards a goal in the right lane. Each basis path comprises a matrix of spatial coordinates for the agent (xᵢ, yᵢ) for a given distance along the road section. The trajectory estimation network is trained as described above to generate a set of weights w₁ⁱ, w₂ⁱ corresponding to the positions of the basis paths at a given distance step i. The predicted path can be generated by multiplying the path weights (Wᵢ¹, Wᵢ²) by the respective basis paths and summing the results, thereby generating a new path. This is equivalent to a matrix operation:

$${P}_{pred} = {P}_{1} {\underline{w}}^{1} + {P}_{2} {\underline{w}}^{2} ,$$

where Pⱼ=(x^{j} y^{j}) are the first and second basis paths each comprising vector of position values x^{j}=(x₁^{j}, . . . , xₙ^{j}) and y^{j}=(y₁^{j}, . . . , yₙ^{j}) for each distance step up to the distance n to the goal, and where w^{j}=(w₁^{j}, . . . wₙ^{j}) is a vector of weights corresponding to the respective basis path as defined at each distance step. Pⱼ may additionally comprise elements (cos(yaw), sin(yaw)), to which the learned weights are applied. The weights for each basis path are applied to the components of a unit vector representation of the yaw angle and a weighted average (yaw)_{pred} and (yaw)_{pred} is generated for each component as described above for x and y components, with the yaw angle for P_{pred} determined by applying an arctan function to the ratio of

$$\frac{{( yaw )}_{pred}}{{( yaw )}_{pred}} .$$

As shown in FIG. 5, the first basis path P₁ shows a relatively long lane change from the left to the right lane to reach the given goal, while the second basis path shows the lane change occurring within a shorter distance. The network-predicted weights determines the relative contribution of each of these basis paths at each timestep in the final predicted path P_{pred}. It should be noted that this is a simplified example to illustrate how paths are combined and does not represent a real path. In reality there may be many more basis paths forming the predicted path, and the weights can vary significantly at different distance steps such that the predicted path is not necessarily a direct combination of two full paths.

This illustrative example refers to the path, i.e. the spatial component of the trajectory only. As described above, weights are also generated from the trajectory estimation network 208 for the basis motion profiles, which are fit as splines to a set of kinematic targets, rather than spatial waypoints. While this is not shown in FIG. 5, the combination of motion profiles to form a predicted motion profile is performed in the same way as the weighted sum described to generate a predicted path, wherein the motion profile is a matrix of motion coordinates such as velocity, acceleration over the set of timesteps up to the given goal, and thus weights of the motion profiles are output by the network for each timestep rather than each distance step. Interpolation can be applied to the predicted path in order to estimate a position at each timestep by first determining a set of distances for each timestep of the motion profile, and interpolating the path based on the motion profile. The predicted path and motion profile can then be combined by concatenating the spatial and motion coordinate values at each timestep to generate an overall predicted trajectory for the given agent and goal.

The above description refers to applications of a trajectory generation network to generate predicted trajectories of agents in a scene. This can be used as part of a prediction component of an autonomous vehicle to generate a set of predicted traces of all agents of a scene (including the ego vehicle), based on which a planning component can plan a trajectory for the ego vehicle that takes other agents' goals and future actions into account.

Another possible application of a neural network for predicting weights for a set of basis paths and motion profiles is in the generation of trajectories in a planning component 106 of an autonomous vehicle stack. As described in International Publication No. WO2021/152047 (the PILOT application), which discloses a planner referred to herein as ‘PILOT’, which is herein incorporated by reference in its entirety, a two-stage planner can be implemented to generate a plan for an ego vehicle towards a predetermined goal in the presence of other agents, where the first stage is a neural network which takes as input a set of predicted traces for the agents of the scene (such as the trajectories generated by the methods described above with reference to FIGS. 1-3).

FIG. 6 shows a block diagram of a neural network for the first stage of the two-stage optimisation planner that generates a trajectory as a combination of basis paths and basis motion profiles generated based on the ego goal. In this case, the ego goal is known, as this is the intended target of the planner, and so a single set of basis paths and basis motion profiles can be determined by fitting splines to the graph representation and the kinematic targets set for example by speed limits within the drivable area as described earlier. The basis path/profile generator 602 receives as input a state of the scene, including a map, and generates the basis paths and motion profiles at a path and motion profile generator 602, which determines a path based on the ego goal as described earlier for the agent goals in the prediction component.

Predicted agent trajectories 610 for external (non-ego) agents of the scenario, which could be generated as described above, are received from a prediction component 104 and passed to the ego trajectory estimation network 604. As described in the PILOT application, the neural network uses imitation learning to approximate the results of a constrained non-linear optimisation which provides a solution close to a globally optimal solution used to seed a second non-linear optimisation stage designed to converge to a more optimal plan. While the PILOT application describes the output of the first stage optimiser as a set of trajectory positions over time, or alternatively as parameters of a set of smooth functions, herein, the ego trajectory is configured to produce a set of weights to be applied to the basis paths and motion profiles generated by the basis path/profile generator 602. Once the weights are output by the network 604, the basis paths and motion profiles can be multiplied by the weights corresponding to the respective positions and kinematic values of the corresponding distance/time steps and summed to generate an ego path and motion profile, and therefore generate an ego trajectory for seeding the second non-linear optimisation stage.

This network is trained as described in the PILOT application, with the additional step of generating the proposed ego trajectory by applying the weights output by the network to the respective basis paths and motion profiles generated earlier before computing the loss function described in the PILOT application, which computes an L2 norm between an ‘expert’ trajectory obtained by non-linear optimisation and the ego trajectory generated based on the network output.

Alternatively, the neural network may be used to directly generate a planned trajectory for the ego agent without further refinement by a second non-linear optimisation stage, where the network is again trained to generate a substantially optimal trajectory for a given set of scenario inputs, such as perception outputs from a perception system and/or predicted behaviour of external agents received from a prediction system 104, by minimising an error between the trajectories generated by the network in training and trajectories generated by an expert planner using, for example, non-linear optimisation.

FIG. 7 shows a representation of the spatial uncertainties output by the network trajectory estimator, overlaid on the example predicted path generated as shown in FIG. 5. As described above, a spatial uncertainty distribution is defined for each timestep and prediction mode. The spatial uncertainty is represented as an elliptical Gaussian centred on the predicted trajectory corresponding to each mode, capturing the uncertainty in the predicted position of the agent in all directions at the given timestep. The mode of the Gaussian is the most probable position of the agent at the given timestep, and the width of the distribution indicates the degree of confidence in the given prediction. The spatial uncertainty distribution can vary with distance, for example uncertainty might increase with the number of timesteps from the current state as more possible futures deviating from the predicted trajectory are possible over time. This is shown by the size of the ellipses in FIG. 5 which increase along the path to the goal. It should be noted that in the present implementation, the spatial uncertainty is calculated for each step in time, and not at equal distance measures along the path.

In a planning context, scenario input(s) provided to a neural network trajectory generator may be obtained using a perception system and, in some cases, a prediction system applied to perception outputs (in more modular systems where prediction is separable from planning). In a prediction context, scenario inputs may be obtained using a perception system. The present techniques can also be employed in simulation in various contexts. In one simulation context, the described stack (or part of it) may be applied to simulated inputs (e.g., derived from synthetic sensor data or using scenario models). In another simulation context, the described trajectory generation techniques may be used to generate agent behaviours in a simulation environment for the purpose of testing some other stack, and the scenario inputs may be generated from simulation ground truth as the scenario progresses. For example, the neural network trajectory generator may be applied to a current ground truth state of the simulation to compute the next state.

A first aspect described herein provides a method of generating at least one trajectory in a scenario comprising an agent navigating a road layout, the method comprising: receiving an observed state of the agent and an indication of the road layout; generating a set of multiple trajectory basis elements from the observed state of the agent based on the road layout; processing one or more scenario inputs in a neural network to generate a set of weights, each weight corresponding to one of the trajectory basis elements; and generating a trajectory for the agent by weighting each trajectory basis element by its corresponding weights and combining the weighted trajectory basis elements.

The observed state of the agent may be the position of the agent within the road layout and variables of motion of the agent, including velocity and acceleration of the agent at a current time, and may additionally comprise historical positions and motion parameters of the agent over a set of past timesteps. The observed state may also include a yaw angle defining the direction of the agent's path relative to the road direction.

The multiple trajectory basis elements may comprise multiple basis paths wherein the weighted basis paths are combined to form a path, the trajectory comprising the path. The multiple trajectory basis elements comprise multiple basis motion profiles, wherein the weighted basis motion profiles are combined to form a motion profile. The multiple trajectory basis elements may comprise both the multiple basis motion profiles and the multiple basis paths, the trajectory comprising the path and the motion profile.

The trajectory basis elements may be generated from a map of the road layout, for example by constructing a graph of waypoints along drivable lanes of the road based on a map. Alternatively, the basis elements may be generated without a map using only the observed states of the agent and any other agents in the scenario, based on any available representation of the road layout.

The method may be used for prediction, to determine a set of possible trajectories that may be taken by a set of agents in a scenario, or for planning, to determine an approximate best trajectory for an ego agent to take in a given scenario, taking into account the road layout and predicted behaviour of other agents in the scenario.

The scenario inputs may comprise the observed state of the agent, which can include a state of the agent at a current timestep as well as a set of historical states of the agent, and observed current and past states of other agents of the scenario. The scenario inputs may also include the generated basis elements. Where used for prediction of multiple agents, a goal and motion profile likelihood estimation may be performed based on the observed states, in order to generated a predicted goal and motion profile for the agents of the scenario. These predictions may also be provided as scenario inputs to the network. For higher level prediction, taking into account an initial prediction for the agents of the scenario, the scenario inputs may also comprise one or more trajectory predictions and one or more collision probabilities for the agents. When used for planning an ego trajectory in a given scenario, a prediction for the agents of the scene is also passed to the network as a scenario input.

When applied to planning, the network may generate a set of trajectory weights defining an initial trajectory that substantially optimises a planning goal, where this initial trajectory is passed to an optimiser for refinement. Alternatively, the generated trajectory may be passed to a controller of the ego agent to execute the planned trajectory.

When applied to prediction, a number of modes may be defined for each agent, and the network may be configured to generate a trajectory for each of the predefined number of modes. The network outputs may additionally comprise spatial uncertainties and mode probabilities associated with the trajectories generated for each agent and mode of the scenario. The spatial uncertainties define a likelihood of the agent's position in a region around the predicted location of the agent's path at a given point in time. This may be defined as an elliptical Gaussian function centred on the predicted location of the agent. The mode probabilities indicate the preferred mode associated with the best trajectory for the given agent, where the highest probability mode is the one whose trajectory the network considers most optimal.

A second aspect herein provides a method of training a neural network for generating a trajectory for an agent, the network comprising a set of network parameters, the method comprising: receiving a set of training data comprising a set of training inputs, each input comprising an observed state of an agent and an indication of a road layout, and a set of corresponding ground truth outputs, each ground truth output comprising an actual trajectory taken by the agent from the observed state; generating a set of multiple trajectory basis elements from the observed state of the agent based on the road layout; processing the training inputs in the neural network to generate a set of weights, each weight corresponding to one of the trajectory basis elements; and generating a trajectory for the agent by weighting each trajectory basis element by its corresponding weights and combining the weighted trajectory basis elements; computing an update to the parameters of the network based on a loss function that penalises deviations between the generated trajectory and the corresponding ground truth output for the agent.

The training data may comprise a set of initial scenario states and historical states for agents in observed, real-world scenarios, for which corresponding subsequent observed trajectories are available for each agent. These observed trajectories are used as ground truth.

In embodiments where multiple modes are defined for each agent, loss function may be defined so as to penalise deviations between the trajectory of the closest mode and the ground truth. In other words, only the error between the closest predicted trajectory and the actual trajectory taken by the agent in the given scenario contributes to the update of the network parameters. Where the network is also configured to compute a spatial uncertainty distribution for each agent and mode, the loss function is defined so as to encourage a high likelihood of the ground truth trajectory according to the given spatial uncertainty distribution. Again, the loss function may only be computed for the preferred mode to encourage higher certainty for good predictions.

The above techniques can be implemented in an “onboard” or “offboard” context. The above techniques can also be implemented as part of a simulated runtime stack in order to test the performance of the runtime stack in a simulator. Simulation is an increasingly crucial component of safety and other performance testing for autonomous vehicles in particular.

References herein to components, functions, modules and the like denote functional components of a computer system which may be implemented at the hardware level in various ways. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). A computer system may be implemented “onboard” a mobile robot (such as an AV) or “offboard” for example in a simulator context.

1. A method of generating at least one trajectory in a scenario comprising an agent navigating a mapped area, the method comprising:
receiving an observed state of the agent and map data of the mapped area;
generating a set of multiple trajectory basis elements from the observed state of the agent based on the map data;
processing one or more scenario inputs in a neural network to generate a set of weights, each weight corresponding to one of the trajectory basis elements; and
generating a trajectory for the agent by weighting each trajectory basis element by its corresponding weights and combining the weighted trajectory basis elements.

2. The method of claim 1, wherein:
the multiple trajectory basis elements comprise multiple basis paths and weighted basis paths are combined to form a path, the trajectory comprising the path; or
the multiple trajectory basis elements comprise multiple basis motion profiles and the weighted basis motion profiles are combined to form a motion profile, the trajectory comprising the motion profile.

3. (canceled)

4. The method of claim 1, wherein:
the multiple trajectory basis elements comprise multiple basis paths and weighted basis paths are combined to form a path;
the multiple trajectory basis elements comprise multiple basis motion profiles and the weighted basis motion profiles are combined to form a motion profile; and
the multiple trajectory basis elements comprise the multiple basis motion profiles and the multiple basis paths, the trajectory comprising the path and the motion profile.

5. The method of claim 2, wherein:
the basis motion profiles are generated based on the observed state of the agent and one or more motion profile parameters; or
the basis motion profiles are generated based on the observed state of the agent and one or more motion profile parameters by fitting a spline between an observed kinematic state of the agent and a target kinematic state of the agent.

6. (canceled)

7. The method of claim 2, wherein:
the map comprises a road layout, and
the method further comprising generating a graph representation of the road layout comprising one or more waypoints, including an observed waypoint and at least one goal waypoint, wherein the multiple basis paths are generated by fitting one or more splines between the observed waypoint and one of the goal waypoints of the graph representation.

8. (canceled)

9. The method of claim 1, wherein the scenario inputs comprise one or more of:
at least one trajectory prediction; or
a likelihood of collision associated with the at least one trajectory prediction.

10. (canceled)

11. (canceled)

12. The method of claim 1, wherein the scenario comprises one or more non-ego agents, and wherein the trajectory generation comprises generating a respective predicted trajectory for the one or more non-ego agents wherein the respective predicted trajectory is passed to a planner for planning a trajectory of an ego vehicle.

13. The method of claim 12, additionally comprising generating estimated likelihoods for one or more goals and/or motion profiles of each of one or more non-ego agents, wherein the scenario inputs comprise the estimated likelihoods.

14. The method of claim 1, applied to plan a trajectory for an ego agent, wherein the trajectory generation comprises generating a candidate planned trajectory for the agent.

15. The method of claim 14, wherein:
the candidate planned trajectory is used to seed a runtime optimizer that generates a final planned trajectory for the agent; or
the candidate planned trajectory is used to seed a runtime optimizer that generates a final planned trajectory for the agent, used to generate control signals for controlling an actor system of the ego agent.

16. (canceled)

17. The method of claim 15, when implemented in a simulation context, wherein the control signals are input to an ego vehicle dynamics model to simulate planned behaviour of the ego agent.

18. The method of claim 1, wherein the trajectory generation further comprises generating one or more spatial uncertainty distributions for the agent, wherein each spatial uncertainty distribution provides a measure of a likelihood of a position of the agent at a given time.

19. The method of claim 18, wherein the generated trajectory and spatial uncertainty distributions are generated for each of a set of equally spaced timesteps.

20. The method of claim 19, wherein the spatial uncertainty distributions are elliptical Gaussian distributions.

21. The method of claim 1, wherein the observed state comprises a position and a velocity of the agent at an initial timestep.

22. The method of claim 1, wherein the trajectory generation comprises generating a trajectory for each of a predefined number of modes, and wherein the method further comprises generating a mode prediction indicating a most likely mode for the agent.

23. The method of claim 12, further comprising a collision assessment step comprising computing a likelihood of collision for each agent of the scenario based on the generated trajectories for all agents.

24. The method of claim 23, wherein:
the trajectory generation further comprises generating one or more spatial uncertainty distributions for the agent, wherein each spatial uncertainty distribution provides a measure of a likelihood of a position of the agent at a given time, and
the collision assessment step comprises computing a collision probability for the agent by evaluating an overlap between a predicted occupied region of the agent at a given timestep and the generated spatial uncertainty distribution of each further agent at the given timestep.

25. The method of claim 24 additionally comprising providing the collision assessment probabilities and generated trajectories to a further neural network configured to generate trajectories for the agents of the scenario.

26. The method of claim 1, wherein a neural network is trained for generating the at least one trajectory, the network comprising a set of network parameters, the method for training the neural network comprising:
receiving a set of training data comprising a set of training inputs, each input comprising an observed state of an agent and an indication of a road layout, and a set of corresponding ground truth outputs, each ground truth output comprising an actual trajectory taken by the agent from the observed state;
generating a set of multiple trajectory basis elements from the observed state of the agent based on the road layout;
processing the training inputs in the neural network to generate a set of weights, each weight corresponding to one of the trajectory basis elements;
generating a trajectory for the agent by weighting each trajectory basis element by its corresponding weights and combining the weighted trajectory basis elements; and
computing an update to the parameters of the network based on a loss function that penalises deviations between the generated trajectory and the corresponding ground truth output for the agent.

27. The method of claim 26, wherein the training data comprises historical trajectories taken by agents in past scenarios, and wherein the trajectories are generated in training from a past observed state and/or the training data comprises a planned agent trajectory generated by a reference planner, the reference planner also having planned from the observed state.

28. (canceled)

29. The method of claim 26, wherein:
a trajectory is generated for each of a predefined number of modes, and wherein the loss function penalises deviations between the ground truth and the generated trajectory which is most similar to the ground truth only; or
the network is configured to generate a spatial uncertainty distribution associated with the generated trajectory, and wherein the loss function encourages spatial uncertainty distributions that assign a high likelihood to the ground truth trajectory.

30. (canceled)

31. The method of claim 29, wherein the network is further configured to generate a mode prediction indicating a probability that each mode is an optimal mode, and wherein the loss function encourages a high probability for the mode whose trajectory is most similar to the ground truth trajectory and a low probability for mode(s) whose trajectories are less similar to the ground truth trajectory.

32. The method of claim 1, comprising generating at least one further trajectory basis element wherein the basis element is not based on the map data.

33. A computer system comprising:
at least one memory configured to store computer-readable instructions;
at least one hardware processor coupled to the at least one memory and configured to execute the computer-readable instructions, which upon execution cause the at least one hardware processor to implement a method of generating at least one trajectory in a scenario comprising an agent navigating a mapped area, the method comprising:
receiving an observed state of the agent and map data of the mapped area;
generating a set of multiple trajectory basis elements from the observed state of the agent based on the map data;
processing one or more scenario inputs in a neural network to generate a set of weights, each weight corresponding to one of the trajectory basis elements; and
generating a trajectory for the agent by weighting each trajectory basis element by its corresponding weights and combining the weighted trajectory basis elements.

34. A non-transitory medium embodying computer-readable instructions configured, when executed on one or more hardware processors, to implement a method of generating at least one trajectory in a scenario comprising an agent navigating a mapped area, the method comprising:
receiving an observed state of the agent and map data of the mapped area;
generating a set of multiple trajectory basis elements from the observed state of the agent based on the map data;
processing one or more scenario inputs in a neural network to generate a set of weights, each weight corresponding to one of the trajectory basis elements; and
generating a trajectory for the agent by weighting each trajectory basis element by its corresponding weights and combining the weighted trajectory basis elements.
